(19) United States
(12) Patent Application Publication
(10) Pub. No.: US 2014/0354631 A1
(43) Pub. Date: Dec. 4, 2014

(54) NON-TRANSITORY STORAGE MEDIUM ENCODED WITH COMPUTER READABLE INFORMATION PROCESSING PROGRAM, INFORMATION PROCESSING APPARATUS, INFORMATION PROCESSING SYSTEM, AND INFORMATION PROCESSING METHOD

(71) Applicant: NINTENDO CO., LTD., Kyoto (JP)

(72) Inventor: Naoki YAMAOKA, Kyoto (JP)

(73) Assignee: NINTENDO CO., LTD., Kyoto (JP)

(21) Appl. No.: 14/024,242

(22) Filed: Sep. 11, 2013

(30) Foreign Application Priority Data
Jun. 4, 2013 (JP) 2013-118108

(51) Int. Cl. G06T 19/20

(52) U.S. Cl. CPC G06T 19/20
USPC 345/419

(57) ABSTRACT

A non-transitory storage medium encoded with a computer readable information processing program is provided. The information processing program, executed by a processing apparatus that is adapted to access a display unit and an input unit, causes the processing apparatus to perform functionality that includes causing a captured image captured by a virtual camera located in a virtual space to be displayed on the display unit, receiving an indicated position on the captured image from the input unit, calculating a position in the virtual space corresponding to the indicated position, and updating the captured image to a state in which ranges close to and distant from the virtual camera with respect to a range proximate to the calculated position are out of focus.

This nonprovisional application is based on Japanese Patent Application No. 2013-118108 filed on Jun. 4, 2013, with the Japan Patent Office, the entire contents of which are hereby incorporated by reference.

### FIELD

The technology herein relates to a non-transitory storage medium encoded with a computer readable information processing program for displaying an image, an information processing apparatus therefor, an information processing system therefor, and an information processing method therefor.

### BACKGROUND AND SUMMARY

A three-dimensional image processing technique is conventionally known in which a virtual object constructed using a polygon is drawn from various directions determined in accordance with a user's operation, thereby enabling a user to observe the virtual object from various angles.

For example, considering the case of capturing an image of a subject by a camera in real space, the camera has a depth of field as an optical property. The depth of field means the distance range from the camera to the subject by which focus appears to be achieved.

Exemplary embodiments provide a non-transitory storage medium encoded with a computer readable information processing program that can give a user a sense of realism such as that obtained when capturing an image by a real camera, an information processing apparatus therefor, an information processing system therefor, and an information processing method therefor.

An exemplary embodiment provides a non-transitory storage medium encoded with a computer readable information processing program, executed by a processing apparatus that is adapted to access a display unit and an input unit, the information processing program causing the processing apparatus to perform functionality that includes causing a captured image captured by a virtual camera located in a virtual space to be displayed on the display unit, receiving an indicated position on the captured image from the input unit, calculating a position in the virtual space corresponding to the indicated position, and updating the captured image to a state in which ranges close to and distant from the virtual camera with respect to a range proximate to the calculated position are out of focus.

According to the exemplary embodiment, upon receipt of the indicated position on the captured image, the processing apparatus calculates a range proximate to a position in the virtual space corresponding to the indicated position, and updates ranges close to and distant from the virtual camera with respect to the proximate range to be out of focus. By such updating being made, a representation such as that produced when capturing an image of a subject by a camera in real space is made, and a sense of realism such as that obtained when capturing an image by a real camera can be given to a user.

In an exemplary embodiment, the step of receiving includes receiving indicated positions repeatedly, and the step of calculating includes repeatedly calculating a corresponding position in the virtual space every time the indicated position is received. According to the exemplary embodiment, since a corresponding position in the virtual space is repeatedly calculated every time the indicated position is received, a configuration suited to displays which are continuous in time (typically, video and animation) can be achieved.

In an exemplary embodiment, the proximate range depends on an optical characteristic set for the virtual camera. In another exemplary embodiment, the proximate range depends on a depth of field set for the virtual camera. According to the exemplary embodiments, a display in which the optical characteristic set for a virtual camera is reproduced can be achieved.

In an exemplary embodiment, the step of updating includes updating to be out of focus as compared with a drawing state of the proximate range. According to the exemplary embodiment, a sense of realism such as that obtained when capturing an image by a real camera can be given to a user.

In an exemplary embodiment, the step of calculating includes calculating a position based on a region in the virtual space corresponding to the indicated position. According to the exemplary embodiment, since the position is calculated from a region having a size, an effect similar to a finder of a real camera can be given to a user.

In the exemplary embodiment, the step of calculating includes calculating a position based on a plurality of coordinates included in the region in the virtual space. According to the exemplary embodiment, since the position is calculated from a plurality of coordinates included in the region, the accuracy of position calculation can be increased.

In the exemplary embodiment, the step of updating includes changing a defocusing degree in accordance with the distance from the virtual camera to the calculated position. According to the exemplary embodiment, even when any position on a captured image is indicated, a position in the virtual space corresponding to that indicated position can be determined appropriately.

In the exemplary embodiment, the step of updating includes determining the proximate range in accordance with the distance from the virtual camera to the calculated position. According to the exemplary embodiment, since the proximate range is determined in accordance with the distance from the virtual camera to the calculated position, that is, the distance to a position on which a user is focusing, an effect similar to the depth of field produced when capturing an image by a real camera can be exerted.

In the exemplary embodiment, the step of updating includes widening the proximate range as the distance from the virtual camera to the calculated position becomes longer. According to the exemplary embodiment, a natural display closer to the state of capturing an image by a real camera can be achieved by decreasing the width of the proximate range when close to the virtual camera and increasing the width of the proximate range when distant from the virtual camera.

In the exemplary embodiment, the step of updating includes gradually increasing a defocusing degree away from the proximate range. According to the exemplary embodiment, a natural display closer to the state of capturing an image by a real camera can be achieved.

In the exemplary embodiment, the step of updating includes determining a relationship between the distance from the virtual camera and the defocusing degree in accordance with at least one of the distance from the virtual camera to the calculated position and an angle of view of the virtual camera. According to the exemplary embodiment, since the relationship between the distance from the virtual camera and the defocusing degree is changed in accordance with at least one of the distance from the virtual camera to the calculated position and the angle of view of the virtual camera, a captured image can be drawn more naturally.

In the exemplary embodiment, the step of updating includes decreasing the amount of change in the defocusing degree relative to the distance as the distance from the virtual camera to the calculated position becomes longer. According to the exemplary embodiment, since the amount of change in the defocusing degree relative to the distance is decreased as the distance from the virtual camera to the calculated position becomes longer, a captured image can be drawn more naturally.

In the exemplary embodiment, the step of updating includes increasing the amount of change in the defocusing degree relative to the distance as the angle of view of the virtual camera becomes larger. According to the exemplary embodiment, since the amount of change in the defocusing degree relative to the distance is increased as the angle of view of the virtual camera becomes larger, a captured image can be drawn more naturally.

In the exemplary embodiment, the step of calculating includes holding a position corresponding to the indicated position independently of a change in a image capturing direction of the virtual camera. According to the exemplary embodiment, the depth position at which focus is achieved can be prevented from being changed unintentionally from the depth position corresponding to the previously indicated position even though a user has not instructed a focusing operation.

An exemplary embodiment provides an information processing apparatus that is adapted to access a display unit and an input unit. The information processing apparatus includes a display control unit configured to cause a captured image captured by a virtual camera located in a virtual space to be displayed on the display unit, an indicated position receiving unit configured to receive an indicated position on the captured image from the input unit, a spatial position calculation unit configured to calculate a position in the virtual space corresponding to the indicated position, and an image updating unit configured to update the captured image to a state in which ranges close to and distant from the virtual camera with respect to a range proximate to the calculated position are out of focus.

An exemplary embodiment provides an information processing system including a display device, an input device, and a processing apparatus. The processing apparatus is configured to perform causing a captured image captured by a virtual camera located in a virtual space to be displayed on the display unit, receiving an indicated position on the captured image from the input device, calculating a position in the virtual space corresponding to the indicated position, and updating the captured image to a state in which ranges close to and distant from the virtual camera with respect to a range proximate to the calculated position are out of focus.

An exemplary embodiment provides an information processing method executed by a processing apparatus that is adapted to access a display unit and an input unit. The information processing method includes the steps of causing a captured image captured by a virtual camera located in a virtual space to be displayed on the display unit, receiving an indicated position on the captured image from the input unit, calculating a position in the virtual space corresponding to the indicated position, and updating the captured image to a state in which ranges close to and distant from the virtual camera with respect to a range proximate to the calculated position are out of focus.

According to the exemplary embodiments, effects similar to those of the above-described exemplary embodiments can be obtained.

The foregoing and other objects, features, and aspects and advantages of the present invention will become more apparent from the following detailed description of the present invention when taken in conjunction with the accompanying drawings.

### BRIEF DESCRIPTION OF THE DRAWINGS

FIG. 1 shows an exemplary illustrative non-limiting schematic diagram illustrating a system configuration of an information processing system according to an exemplary embodiment.

FIG. 2 shows another exemplary illustrative non-limiting schematic diagram illustrating a system configuration of an information processing system according to an exemplary embodiment.

FIG. 3 shows an exemplary illustrative non-limiting diagram illustrating an exemplary arrangement of objects in a virtual space to be subjected to information processing according to an exemplary embodiment.

FIGS. 4A to 4 C show exemplary illustrative non-limiting diagrams illustrating an exemplary result of processing on the virtual space shown in FIG. 3.

FIG. 5 shows an exemplary illustrative non-limiting flowchart illustrating a procedure of information processing according to an exemplary embodiment.

FIG. 6 shows an exemplary illustrative non-limiting schematic diagram illustrating a functional configuration of a processing apparatus for information processing according to an exemplary embodiment.

FIGS. 7A and 7B show exemplary illustrative non-limiting explanatory diagrams of processing of calculating a depth position in information processing according to an exemplary embodiment.

FIG. 8 shows an exemplary illustrative non-limiting explanatory drawing of processing of updating to be out of focus by information processing according to an exemplary embodiment.

FIGS. 9A, 9B, 10A, and 10B show exemplary illustrative non-limiting explanatory drawings of relationship between parameters of a virtual camera and a defocusing degree profile according to an exemplary embodiment.

FIGS. 11A to 11D show exemplary illustrative non-limiting diagrams illustrating variations of defocusing degree profile according to an exemplary embodiment.

### DETAILED DESCRIPTION OF NON-LIMITING EXAMPLE EMBODIMENTS

The present embodiment will be described below in detail with reference to the drawings. It is noted that, in the drawings, the same or corresponding portions have the same reference characters allotted, and detailed description thereof will not be repeated.

<A. System Configuration>

First, a system configuration of an information processing system according to an embodiment will be described.

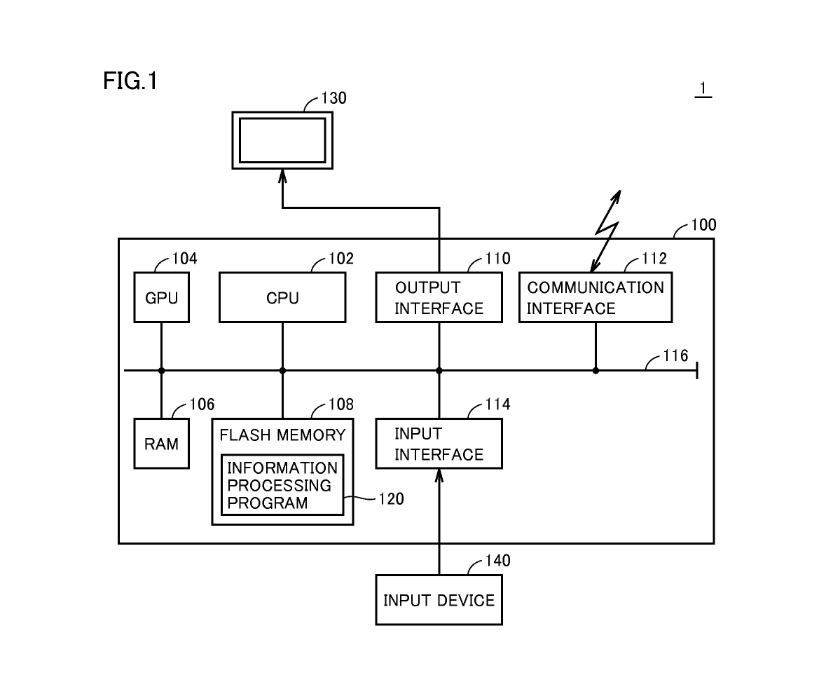

Referring to FIG. 1, an information processing system 1 according to the present embodiment includes a processing apparatus 100, a display device 130 and an input device 140. It is assumed that information processing system 1 shown in FIG. 1 is typically mounted as a personal computer, a console-type game device, a set top box, or the like. Processing apparatus 100 is an essential part of implementing which executes various types of processing according to the present embodiment. Processing apparatus 100 executes various types of processing including information processing in response to a command given by a user operating input device 140, and outputs a result thus obtained (a captured image) to display device 130.

Display device 130 can be implemented by any device that can display a captured image in accordance with a signal (command) from processing apparatus 100. Typically, a liquid crystal display, a plasma display, an organic electroluminescence display, or the like can be adopted as display device 130. As input device 140, various operation buttons, a keyboard, a touch panel, a mouse, an operating stick, or the like can be adopted.

Processing apparatus 100 includes, as main hardware, a CPU (Central Processing Unit) 102, a GPU (Graphical Processing Unit) 104, a RAM (Random Access Memory) 106, a flash memory 108, an output interface 110, a communication interface 112, and an input interface 114. These components are connected to one another via a bus 116.

CPU 102 is an essential part of processing which executes various programs. GPU 104 executes processing of producing a captured image as will be described later, in cooperation with CPU 102. RAM 106 functions as a working memory which stores data, parameters, and the like necessary for execution of a program in CPU 102 and GPU 104. Flash memory 108 stores in a nonvolatile manner an information processing program 120 executed in CPU 102, various parameters set up a user, and the like.

Output interface 110 outputs a video signal or the like to display device 130 in accordance with an internal command from CPU 102 and/or GPU 104. Communication interface 112 sends/receives data to/from another device by wire or wirelessly. Input interface 114 receives an operation signal from input device 140 for output to CPU 102.

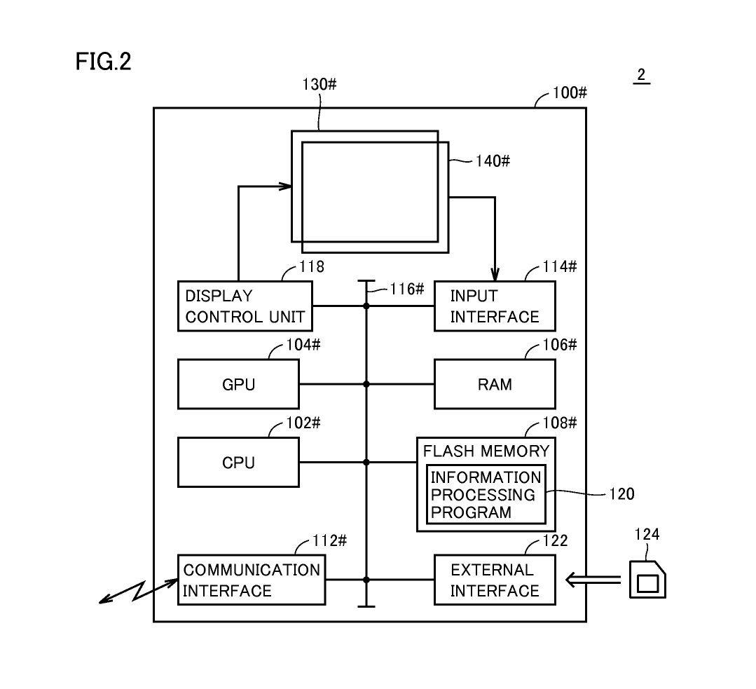

Although information processing system 1 shown in FIG. 1 is illustrated as being configured such that display device 130 and input device 140 are provided separately from processing apparatus 100, they may be configured integrally. An information processing system 2 shown in FIG. 2 includes a processing apparatus 100# having a display function and an input function. It is noted that, among the components shown in FIG. 2, components substantially the same as those shown in FIG. 1 are represented by the same reference numbers, and similar components are represented by the same reference numbers followed by #. It is assumed that information processing system 2 shown in FIG. 2 is typically implemented as a Smartphone, a PDA (Personal Digital Assistance), a mobile phone, a mobile gaming device, a digital camera, or the like. An external interface 122 is capable of reading, from non-transitory recording medium 124 of any type, data such as a program stored therein, and writing various types of data stored in flash memory 108# or the like to non-transitory recording medium 124.

The configurations shown in FIGS. 1 and 2 are not limitations, but any system or apparatus that is configured to include an essential part of processing, a display unit and an input unit may be adopted. That is, the processing apparatus according to the present embodiment may be implemented in any form that is adapted to access a display unit and an input unit.

As described above, information processing system 1 according to the present embodiment includes display device 130, input device 140 and processing apparatus 100. Alternatively, according to another embodiment, an information processing apparatus (processing apparatus 100#) that is adapted to access a display unit and an input unit is provided.

Furthermore, the present embodiment is embodied as information processing program 120 executed by the processing apparatus that is adapted to access a display unit and an input unit and as an information processing method executed in the processing apparatus that is adapted to access a display unit and an input unit.

For ease of description, basically, exemplary processing in the case where an information processing program is executed in information processing system 1 shown in FIG. 1 will be described.

<B. Summary of Processing>

A summary of processing related to information processing according to the present embodiment will be given below.

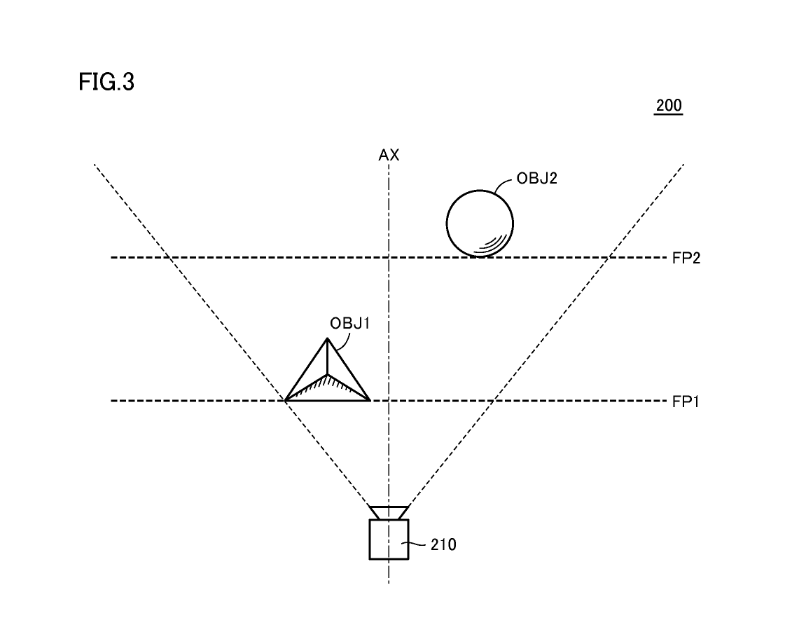

As shown in FIG. 3, a plurality of objects OBJ1, OBJ2 are located in a virtual space 200, and a captured image obtained by capturing an image of these objects by a virtual camera 210 is produced. The sight line direction of virtual camera 210 will be called a camera direction (optical axis direction) AX. A position in this camera direction will also be called a depth direction.

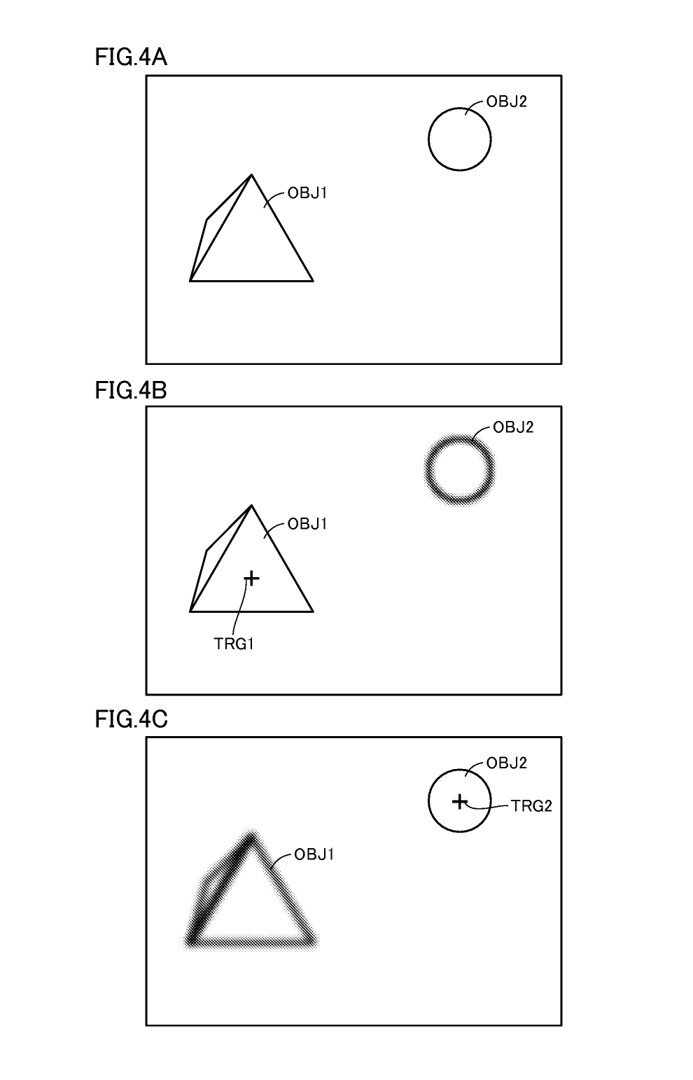

FIG. 4A shows an example of a captured image produced by virtual camera 210 shown in FIG. 3 capturing an image of the objects in virtual space 200. In the captured image shown in FIG. 4A, object OBJ1 located at a position closer to virtual camera 210 is drawn larger in virtual space 200, and object OBJ2 located at a position more distant from virtual camera 210 is drawn smaller. Basically, as for the captured image shown in FIG. 4A, the state of focus is identical in the depth direction. That is, all the objects in the field of view of virtual camera 210 are drawn in focus.

The information processing according to the present embodiment provides processing that can give a user a sense of realism such as that obtained when capturing an image by a real camera. Specifically, when capturing an image by a real camera, a subject to be subjected to image capturing is indicated, and an optical system is adjusted such that the indicated subject comes into focus. Since a camera has a depth of field as an optical property, a subject in focus is seen more sharply, while a subject out of focus is seen indistinctly.

Such actual focus adjustment is considered. In such a case where objects are located at a plurality of different depth positions, when one of the objects is brought into focus, another object is naturally seen indistinctly. The present embodiment gives a user a sense of realism such as that obtained when capturing an image of a subject by a real camera.

For example, as shown in FIG. 4B, when a target TRG1 is set as object OBJ1, object OBJ1 is drawn in focus, and object OBJ2 is drawn out of focus. At this time, the range to be drawn in focus is determined based on a depth position FP1 (FIG. 3) corresponding to object OBJ1.

As shown in FIG. 4C, when a target TRG2 is set as object OBJ2, object OBJ2 is drawn in focus, and object OBJ1 is drawn out of focus. At this time, the range to be drawn in focus is determined based on a depth position FP2 (FIG. 3) corresponding to object OBJ2.

In this manner, the range proximate to the depth position corresponding to an indicated object is drawn in focus, that is, sharply, and the remaining range is drawn out of focus. In the present embodiment, the range shown in focus and the range shown out of focus are dynamically changed in accordance with a user's instruction. Execution of such information processing can give a user a sense of realism such as that obtained when capturing an image by a real camera.

<C. Procedure>

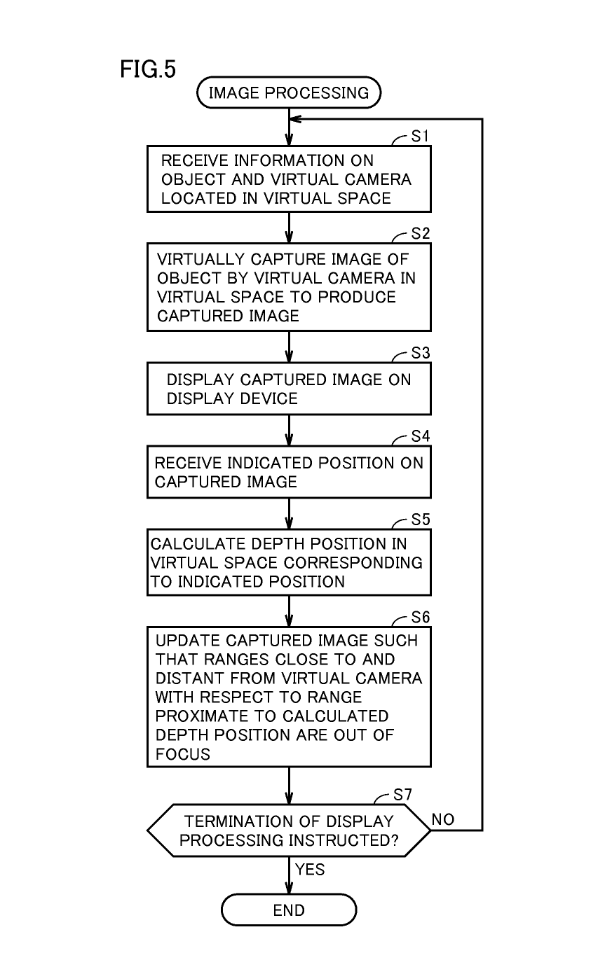

Referring to FIG. 5, a procedure of information processing according to the present embodiment will be described below.

Each step shown in FIG. 5 is typically achieved by CPU 102 (FIG. 1) of processing apparatus 100 executing information processing program 120. Referring to FIG. 5, CPU 102 of processing apparatus 100 receives information on the objects and a virtual camera located in a virtual space (step S1). Subsequently, CPU 102 causes a virtual camera to virtually capture an image of an object in the virtual space to produce (render) a captured image (step S2), and causes the produced captured image to be displayed on display device 130 (step S3). CPU 102 then receives an indicated position on the captured image from input device 140 (step S4). Typically, as shown in FIG. 4A, a position is indicated on the displayed captured image.

When a position is indicated by a user, CPU 102 calculates the depth position in the virtual space corresponding to the indicated position (step S5). When this depth position is calculated, CPU 102 updates the captured image such that the ranges close to and distant from the virtual camera with respect to a range proximate to the calculated depth position are out of focus (step S6). As seen from the user, in the captured image displayed previously, (part of) an object corresponding to the range (in the depth direction) distant from the range proximate to the calculated depth position is displayed out of focus.

Thereafter, CPU 102 determines whether or not termination of display processing has been instructed (step S7). When termination of display processing has not been instructed (NO in step S7), processing of and after step S1 is repeated. That is, CPU 102 repeatedly receives indicated positions, and repeatedly calculates a corresponding position in the virtual space every time an indicated position is received.

On the other hand, when termination of display processing has been instructed (YES in step S7), processing is terminated.

<D. Functional Configuration>

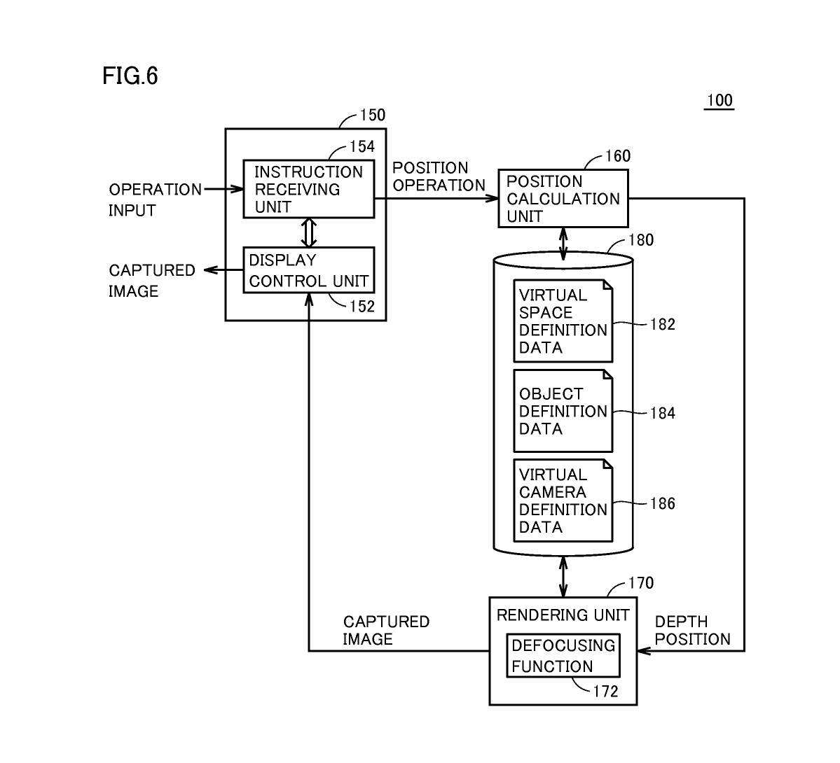

Referring to FIG. 6, a functional configuration for processing apparatus 100 according to the present embodiment to achieve the above-described information processing will be described below.

Processing apparatus 100 includes, as its control configuration, an interface processing unit 150, a position calculation unit 160, a rendering unit 170, and a data storage unit 180. Interface processing unit 150, position calculation unit 160 and rendering unit 170 shown in FIG. 6 are typically implemented by CPU 102 (FIG. 1) of processing apparatus 100 executing information processing program 120.

Interface processing unit 150 causes a captured image captured by the virtual camera located in the virtual space to be displayed on the display unit, and receives an indicated position on the captured image from the input unit. More specifically, interface processing unit 150 includes a display control unit 152 causing a captured image to be displayed on display device 130 or the like, and an instruction receiving unit 154 receiving an operation input from a user. Instruction receiving unit 154 outputs information on a position operation which is a user's instruction on the captured image, to position calculation unit 160.

Position calculation unit 160 calculates the depth position in the virtual space corresponding to the indicated position. More specifically, position calculation unit 160 calculates the depth position corresponding to the user's indicated position from information on the objects and the virtual camera in the virtual space or the like, in response to a position operation through display control unit 152.

Rendering unit 170 produces a captured image obtained by rendering (virtually capturing an image) in the virtual space with reference to virtual space definition data 182, object definition data 184, virtual camera definition data 186, and the like stored in data storage unit 180. Upon receipt of information on the depth position from position calculation unit 160, rendering unit 170 updates the captured image such that the ranges close to and distant from the virtual camera with respect to the range proximate to the calculated depth position are out of focus. Rendering unit 170 has a defocusing function 172. This defocusing function 172 achieves drawing out of focus.

Data storage unit 180 holds virtual space definition data 182, object definition data 184 and virtual camera definition data 186. Virtual space definition data 182 includes various set values concerning the virtual space and the like. Object definition data 184 includes various set values concerning objects located in the virtual space and the like. Virtual camera definition data 186 includes various set values concerning the virtual camera located in the virtual space and the like. The contents of object definition data 184 and/or virtual camera definition data 186 may be appropriately updated along with the progress of related information processing (typically, game processing).

Hereinafter, more detailed processing in the main steps shown in FIG. 5 and a corresponding functional module shown FIG. 6 will be described.

<E. Calculation of Depth Position by Position Calculation Unit 160>

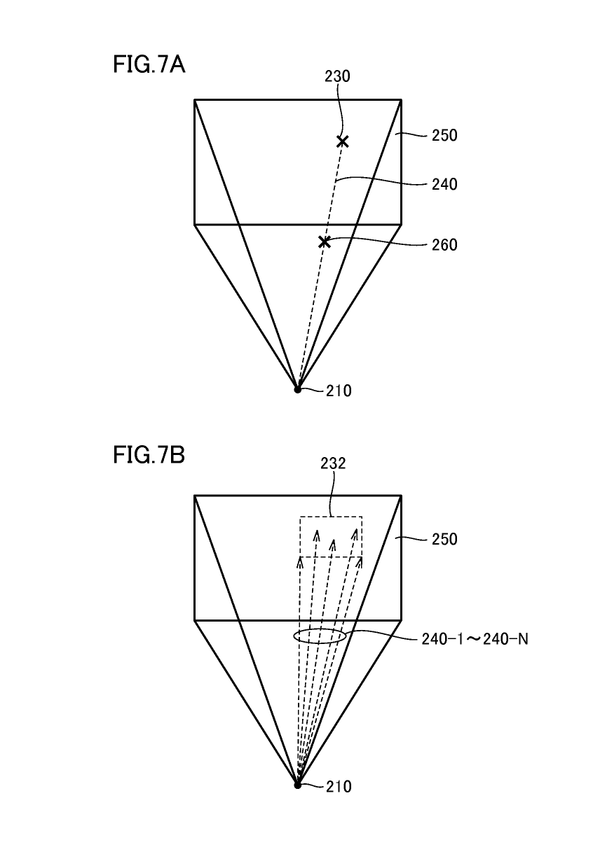

As described above, when a certain position is indicated from input device 140, the depth position in the virtual space corresponding to that indicated position is calculated. Referring to FIGS. 7A and 7B, this processing of calculating the depth position will be described.

FIG. 7A shows the case of determining the depth position corresponding to an indicated position, and FIG. 7B shows the case of determining the depth position corresponding to an indicated region.

Virtual camera 210 located in the virtual space virtually captures an image of objects included in a view volume 250 in accordance with its angle of view to produce a captured image.

FIG. 7A shows processing in the case where virtual camera 210 virtually captures an image of in the virtual space. Suppose that, with a captured image being displayed on display device 130, a user indicates any position (selected position 230) on the captured image being displayed. Position calculation unit 160 obtains a coordinate corresponding to selected position 230 on the captured image, and causes virtual camera 210 to emit a virtual control ray (hereinafter also called a “ray”) 240 based on the obtained coordinate. This emission angle of ray 240 is determined depending on the coordinate of selected position 230 on the captured image and the captured image as well as the angle of view of virtual camera 210. Position calculation unit 160 then determines whether or not ray 240 intersects (hits) some object (or some geometry) located in the virtual space.

In the case where ray 240 hits some object (or some geometry), position calculation unit 160 calculates a coordinate where the hit has been made, and calculates the depth position of the calculated coordinate. Alternatively, a coordinate representing the hit object (e.g., a central coordinate or a coordinate of center of gravity of the object) is calculated. This depth position calculated corresponds to the depth position in the virtual space at the indicated position.

On the other hand, in the case where ray 240 does not hit any object (or any geometry), position calculation unit 160 outputs a predetermined depth position as the depth position in the virtual space at the indicated position.

It is noted that, even if ray 240 hits some object (or some geometry), when a point where the hit has been made is not included in a predetermined range, the predetermined depth position may be output as the depth position in the virtual space at the indicated position.

In this manner, the processing of calculating the depth position in the virtual space corresponding to the indicated position includes processing of calculating a position from the coordinate in the virtual space corresponding to the indicated position (selected position 230). That is, the depth position corresponding to one spot (point) indicated by the user is determined.

It is noted that, considering a real camera, a region defined in the finder shall be a region to be brought into focus in many cases. When imitating such a real camera, processing in which the user indicates a region to be brought into focus on the captured image being displayed and a corresponding depth position is determined based on this indicated region may be preferable.

FIG. 7B shows exemplary processing of calculating the depth position based on a region in the virtual space corresponding to an indicated position. More specifically, suppose that, with the captured image being displayed on display device 130, the user instructs a region (selected region 232) centering on any position of the captured image being displayed. Position calculation unit 160 obtains coordinates of vertices that define selected region 232 on the captured image, and causes virtual camera 210 to emit a plurality of rays 240-1 to 240-N based on the obtained coordinates, respectively. The emission angle of rays 240-1 to 240-N is determined depending on the coordinates on the captured image of selected region 232 and the captured image as well as the angle of view of virtual camera 210. Position calculation unit 160 determines whether or not each of rays 240-1 to 240-N intersects (hits) some object (or some geometry) located in the virtual space.

Position calculation unit 160 extracts rays among rays 240-1 to 240-N having hit some object (or some geometry), and calculates (basically, a plurality of) coordinates where each of the extracted rays has made the hit. Position calculation unit 160 calculates the depth position based on the calculated coordinates. That is, the processing of calculating the depth position in the virtual space corresponding to the indicated position includes processing of determining coordinates from a plurality of coordinates included in the region in the virtual space. That is, a plurality of depth positions corresponding to a plurality of spots (points) included in the region indicated by the user are extracted, and from among them, a representative depth position is determined.

A representative value of the depth position may be determined by performing various types of statistical processing on the plurality of depth positions thus extracted. As an example of such statistical processing, processing of determining an average value, a medium value, a highest frequency value, or the like as a representative value is conceivable. Of course, the statistical processing is not limited to these enumerated types of processing, but any statistical processing can be adopted.

That is, the processing of calculating the depth position in the virtual space corresponding to the indicated position includes processing of performing statistical processing on a plurality of coordinates included in a region in the virtual space, thereby determining a single coordinate.

It is noted that, if none of plurality of rays 240-1 to 240-N hits any object (or any geometry), position calculation unit 160 outputs a predetermined depth position as the depth position in the virtual space at the indicated position. Alternatively, when the calculated depth position is not included in the predetermined range, the predetermined depth position may be output as the depth position in the virtual space at the indicated position.

When calculating the depth position, processing of restricting the depth position calculated, namely, processing of calculating the position in a predetermined region in the virtual space may be included. In other words, a corresponding depth position may be clamped.

Through the processing as described above, the corresponding depth position in the virtual space, that is, a reference position for determining a range to be updated to be out of focus is calculated.

It is noted that, once the corresponding depth position in the virtual space is calculated, even if the image capturing direction of virtual camera 210 is changed, the depth determined at the previously indicated position may be kept in focus. That is, even if the image capturing direction of virtual camera 210 is changed, the position corresponding to the indicated position may be held. By adopting such processing, the depth position in focus can be prevented from changing unintentionally from the depth position corresponding to the previously indicated position even though the user has not instructed a focusing operation. For example, even if a subject has come out of the field of view of virtual camera 210 in such a case where virtual camera 210 is moved in the virtual space, focus established on the subject can be prevented from being changed unintentionally.

<F. Processing of Updating to be Out of Focus by Rendering Unit 170>

Processing of updating to defocusing function 172 mounted on rendering unit 170 will be described below.

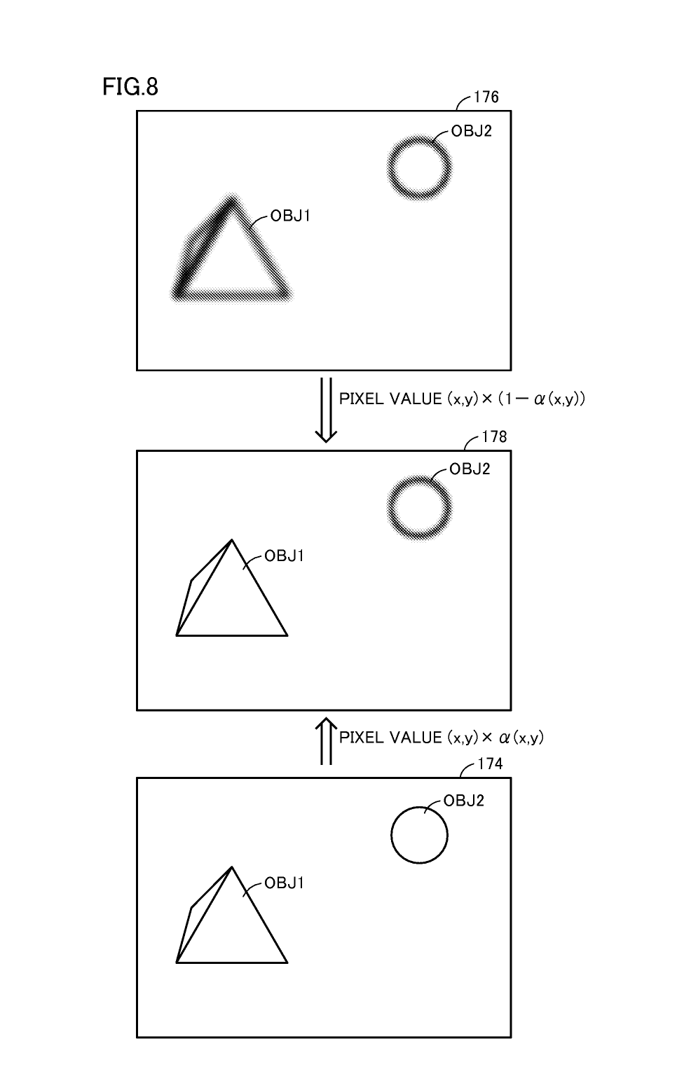

Referring to FIG. 8, rendering unit 170 produces, as defocusing function 172, a clarified image 174 produced by virtually capturing an image of objects in the virtual space in substantially identical focus in the depth direction and a defocused image 176 produced by virtually capturing an image of the objects in the virtual space out of focus. Rendering unit 170 then uses a mixing ratio α(x, y) at each pixel position determined by a method as will be described later to mix, for each pixel, a corresponding pixel value of clarified image 174 and a corresponding pixel value of defocused image 176, thereby producing a target captured image 178

That is, the pixel value at each pixel position (x, y) is calculated in accordance with Expression (1) indicated below.

Pixel value (x,y)=pixel value (x,y) of clarified image 174×α(x,y)+pixel value (x,y) of defocused image 176×(1−α(x,y)) (1)

Mixing ratio α(x, y) is dynamically determined depending on the corresponding depth position of the pixel position (x, y) in the virtual space. That is, the defocusing degree at each depth position is determined based on a defocusing degree profile in the depth direction as will be described later.

<G. Defocusing Degree Profile>

The defocusing degree profile produced by the information processing according to the present embodiment will be described below. In the present embodiment, the range of the depth position updated to be out of focus is adjusted in association with a parameter concerning the virtual camera. In the following description, the relationship between the distance from the virtual camera (depth position) and the defocusing degree will be called “a defocusing degree profile.” That is, in the processing of drawing a captured image according to the present embodiment, the defocusing degree is varied depending on the distance from virtual camera 210 to a calculated position (reference depth distance).

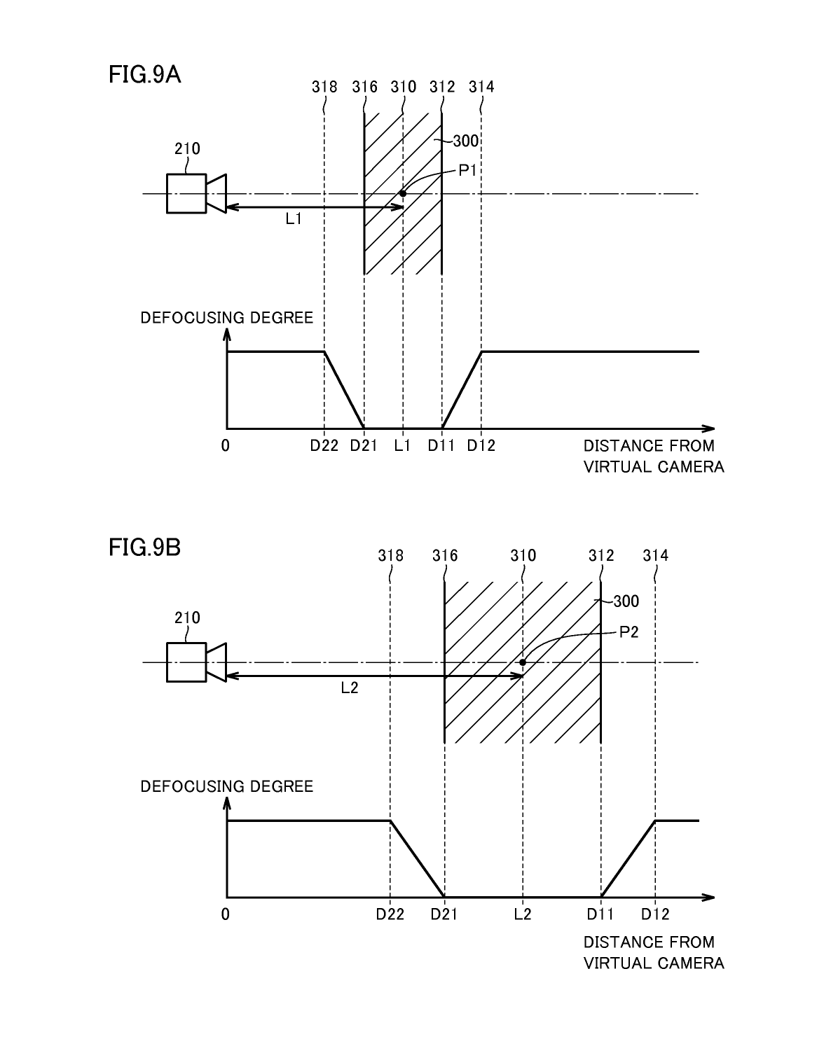

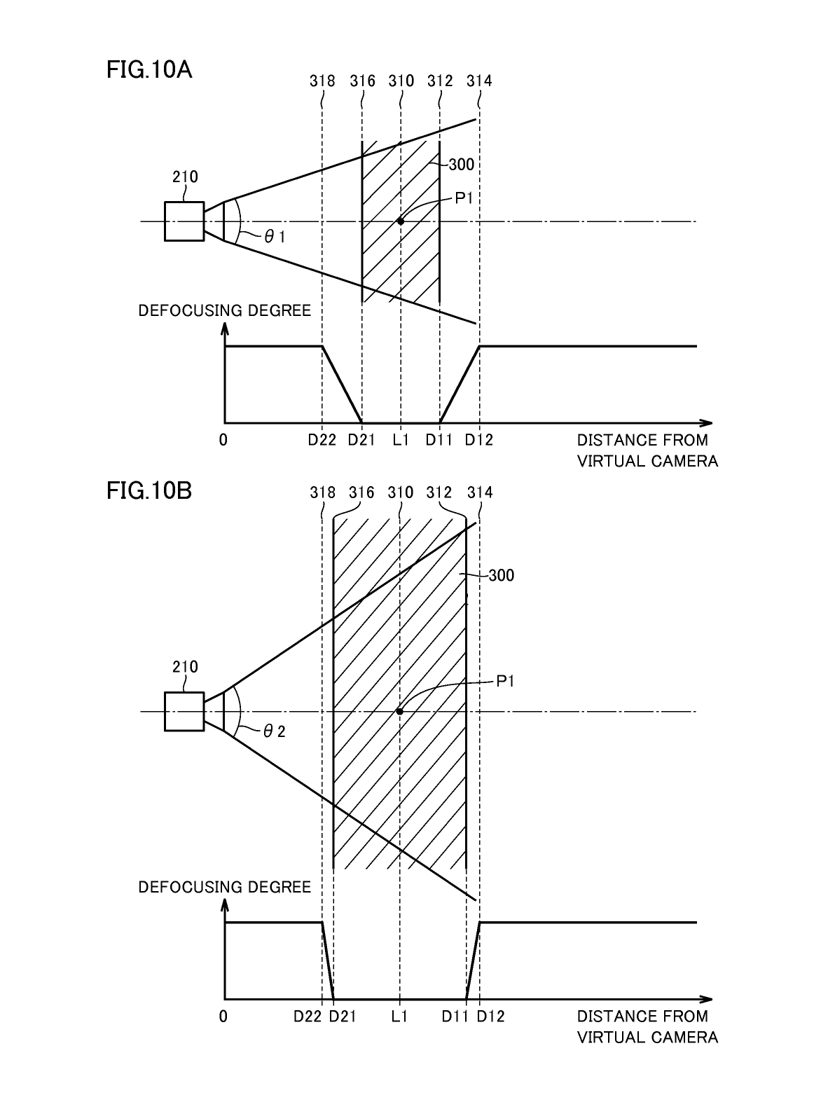

Referring to FIGS. 9A, 9B, 10A, and 10B, processing of dynamically varying the defocusing degree profile will be described.

Basically, a range except a range centering on the depth position corresponding to the indicated position is updated to be out of focus. That is, in the processing of drawing a captured image, as compared with the drawing state of a proximate range centering on the depth position, the remaining range is drawn out of focus.

In the present embodiment, the range in the depth direction in which a drawing is to be made in focus (sharply) and the range in the depth direction to be updated to be out of focus are determined at least depending on the depth position corresponding to the indicated position and/or the angle of view of virtual camera 210.

As an example, as shown in FIGS. 9A, 9B, 10A, and 10B, a range 300 in which a drawing is to be made in focus is set centering on the corresponding depth position. The defocusing degree is continuously varied in ranges continuous with this range 300. Such a defocusing degree profile is defined by a reference depth position 310, a backside defocusing start position 312, a backside defocusing completion position 314, a front side defocusing start position 316, and a front side defocusing completion position 318. Here, reference depth position 310 corresponds to the depth position in the virtual space corresponding to an indicated position. The distance from virtual camera 210 to reference depth position 310 will be called “a reference depth distance.”

Backside defocusing start position 312, backside defocusing completion position 314, front side defocusing start position 316, and front side defocusing completion position 318 are calculated in accordance with Expressions (2) to (5) indicated below, respectively, for example.

Backside defocusing start distance D11=reference depth distance+(A+reference depth distance×β)×γ(θ) (2)

Backside defocusing completion distance D12=D11+reference depth distance×β (3)

Front side defocusing start distance D21=reference depth distance−(A+reference depth distance×β)×γ(θ) (4)

Front side defocusing completion distance D22=D21−reference depth distance×β (5)

Here, A indicates a predetermined offset value, β indicates a predetermined first correction value, and γ(θ) indicates a second correction value depending on the angle of view of virtual camera 210.

FIGS. 9A and 9B show an exemplary change in the defocusing degree profile along with a change in the distance (reference depth distance) from virtual camera 210 to reference depth position 310. FIG. 9A shows an example of backside defocusing start position 312, backside defocusing completion position 314, front side defocusing start position 316, and front side defocusing completion position 318 at a reference depth distance L1. FIG. 9B shows an example of backside defocusing start position 312, backside defocusing completion position 314, front side defocusing start position 316, and front side defocusing completion position 318 at a reference depth distance L2 (>L1).

As is clear from the comparison between FIGS. 9A and 9B, range 300 to be updated into focus becomes wider as the reference depth distance becomes longer. The ranges in which a change from the start of defocusing to the completion of defocusing is made also become wider as the reference depth distance becomes longer. That is, the proximate ranges are made larger as the distance from virtual camera 210 to the calculated position becomes longer.

By thus causing the ranges to be updated to be out of focus to depend on the reference depth distance, a natural display closer to the state of capturing an image by a real camera can be achieved.

In this manner, in the processing of drawing a captured image according to the present embodiment, the proximate range to be updated into focus is determined in accordance with the distance (reference depth distance) from virtual camera 210 to the calculated position (reference depth position 310). In other words, in the processing of drawing a captured image according to the present embodiment, the defocusing degree is gradually increased away from the proximate range to be updated into focus.

This proximate range is determined depending on the optical characteristics set for virtual camera 210. As such optical characteristics, various types of parameters can be adopted. Typically, the proximate range is determined depending on the depth of field set for virtual camera 210.

In this manner, by gradually increasing the defocusing degree away from the proximate range to be updated into focus, that is, by decreasing the width of the proximate range when close to virtual camera 210 and increasing the width of the proximate range when distant from virtual camera 210, a natural display closer to the state of capturing an image by a real camera can be achieved.

FIGS. 10A and 10B show an exemplary change in the defocusing degree profile along with a change in the angle of view of virtual camera 210. FIG. 10A shows an example of backside defocusing start position 312, backside defocusing completion position 314, front side defocusing start position 316, and front side defocusing completion position 318 in the case where the angle of view of virtual camera 210 is θ1. FIG. 10B shows an example of backside defocusing start position 312, backside defocusing completion position 314, front side defocusing start position 316, and front side defocusing completion position 318 in the case where the angle of view of virtual camera 210 is θ2 (>θ1).

As is clear from the comparison between FIGS. 10A and 10B, range 300 to be updated into focus becomes wider as the angle of view of virtual camera 210 becomes larger. On the other hand, the ranges in which a change from the start of defocusing to the completion of defocusing is made becomes smaller as the angle of view of virtual camera 210 becomes larger. That is, the change from the start of defocusing to the completion of defocusing becomes sharper as the angle of view of virtual camera 210 becomes larger.

In this manner, by causing the range to be updated to be out of focus to depend on the angle of view of virtual camera 210, that is, by increasing the range to be brought into focus with a change in the angle of view of virtual camera 210, a natural display closer to the state of capturing an image by a real camera can be achieved.

It is noted that, although FIGS. 9A, 9B, 10A, and 10B show the examples in which the defocusing degree is linearly changed from the start of defocusing to the completion of defocusing depending on the distance from virtual camera 210, they are not limitations, but any changing characteristic can be adopted.

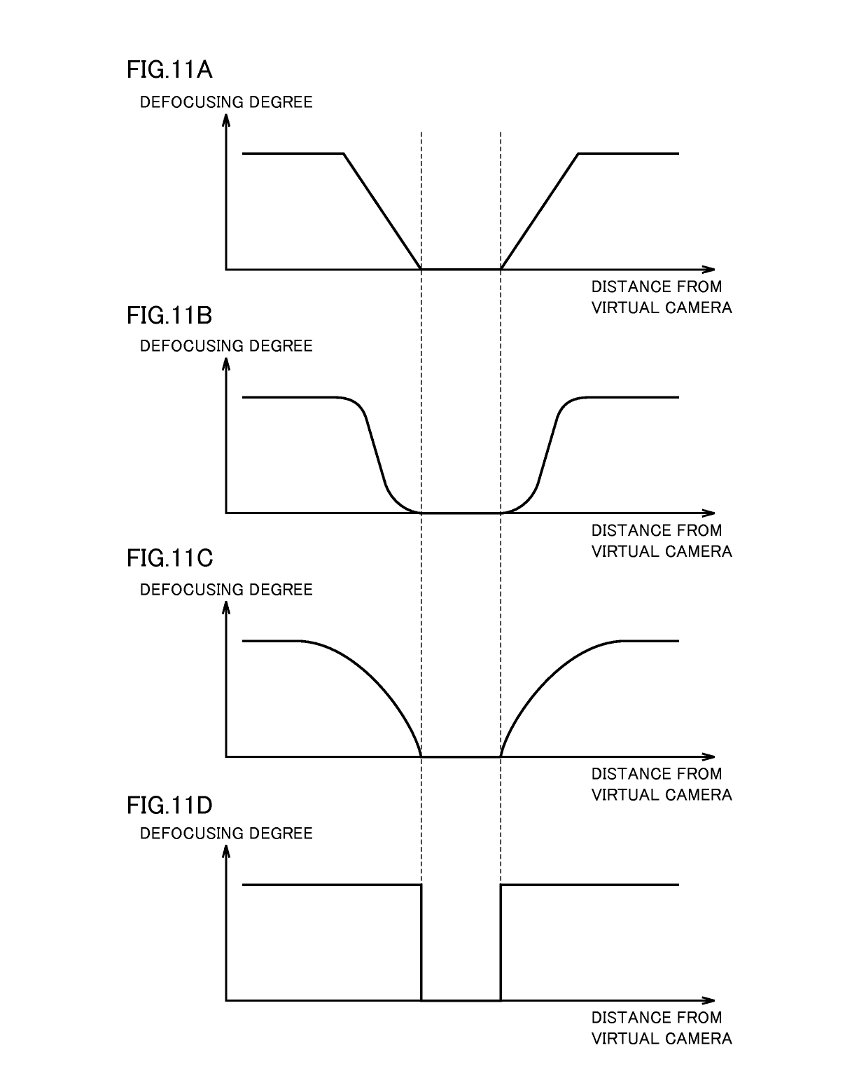

Referring to FIGS. 11A to 11D, a variation of the defocusing degree profile according to the present embodiment will be described. As shown in FIG. 11A, the defocusing degree may be increased in proportion to the distance from virtual camera 210, or as shown in FIGS. 11B and 11C, the defocusing degree may be increased nonlinearly relative to the distance from virtual camera 210. Alternatively, as shown in FIG. 11D, a drawing may be made with the defocusing degree set at zero in a certain range, and when the degree exceeds that range, the defocusing degree may be maximized. That is, a changing profile of the defocusing degree in which no intermediate defocusing degree exists may be adopted.

As described above, in the processing of drawing a captured image according to the present embodiment, the changing profile of the defocusing degree is determined depending on at least one of the distance (reference depth distance) from virtual camera 210 to the calculated position (reference depth position 310) and the angle of view of virtual camera 210.

More specifically, as shown in FIGS. 9A and 9B, the changing profile of the defocusing degree is determined such that the amount of change in the defocusing degree relative to the distance decreases as the distance (reference depth distance) from virtual camera 210 to the calculated position becomes longer.

As shown in FIGS. 10A and 10B, the changing profile of the defocusing degree is determined such that the amount of change relative to the distance increases as the angle of view of virtual camera 210 becomes larger.

By thus changing the defocusing degree in accordance with the reference depth position, settings of virtual camera 210 and the like, a natural display closer to the state of capturing an image by a real camera can be achieved.

<H. Variation>

Although the above-described embodiment illustrates the processing of changing the defocusing degree profile and the like depending on the distance (reference depth distance) from virtual camera 210 to the calculated position and/or the angle of view of virtual camera 210, the defocusing degree profile may be dynamically changed depending on a parameter different from them.

For example, when the information processing according to the present embodiment is applied to an application in which the position of virtual camera 210 in the virtual space is changed with time, that is, virtual camera 210 is moved, the defocusing degree profile may be dynamically changed in accordance with the moving speed of virtual camera 210. More specifically, a sense of speed can be given to a user by narrowing the range in the depth direction in which drawing is made in focus (sharply) as the moving speed of virtual camera 210 becomes higher.

Furthermore, the defocusing degree profile may be dynamically changed depending on the brightness in the virtual space or the like.

<I. Advantage>

As described above, according to the present embodiment, a sense of realism such as that obtained when capturing an image by a real camera can be given to a user.

While certain example systems, methods, devices and apparatuses have been described herein, it is to be understood that the appended claims are not to be limited to the systems and methods, devices and apparatuses disclosed, but on the contrary, and are intended to cover various modifications and equivalent arrangements included within the spirit and scope of the appended claims.

What is claimed is:

1. A non-transitory storage medium encoded with a computer readable information processing program, executed by a processing apparatus that is adapted to access a display unit and an input unit, the information processing program causing the processing apparatus to perform functionality comprising:
causing a captured image captured by a virtual camera located in a virtual space to be displayed on the display unit;
receiving an indicated position on the captured image from the input unit;
calculating a position in the virtual space corresponding to the indicated position; and
updating the captured image to a state in which ranges close to and distant from the virtual camera with respect to a range proximate to the calculated position are out of focus.

2. The non-transitory storage medium according to claim 1, wherein
the receiving includes receiving indicated positions repeatedly, and
the calculating includes repeatedly calculating a corresponding position in the virtual space every time the indicated position is received.

3. The non-transitory storage medium according to claim 1, wherein the proximate range depends on an optical characteristic set for the virtual camera.

4. The non-transitory storage medium according to claim 3, wherein the proximate range further depends on a depth of field set for the virtual camera.

5. The non-transitory storage medium according to claim 1, wherein the updating includes updating to be out of focus as compared with a drawing state of the proximate range.

6. The non-transitory storage medium according to claim 1, wherein the calculating includes calculating a position based on a region in the virtual space corresponding to the indicated position.

7. The non-transitory storage medium according to claim 6, wherein the calculating includes calculating a position based on a plurality of coordinates included in the region in the virtual space.

8. The non-transitory storage medium according to claim 1, wherein the updating includes changing a defocusing degree in accordance with the distance from the virtual camera to the calculated position.

9. The non-transitory storage medium according to claim 1, wherein the updating includes determining the proximate range in accordance with the distance from the virtual camera to the calculated position.

10. The non-transitory storage medium according to claim 9, wherein the updating includes widening the proximate range as the distance from the virtual camera to the calculated position becomes longer.

11. The non-transitory storage medium according to claim 1, wherein the updating includes gradually increasing a defocusing degree away from the proximate range.

12. The non-transitory storage medium according to claim 11, wherein the updating includes determining a relationship between the distance from the virtual camera and the defocusing degree in accordance with at least one of the distance from the virtual camera to the calculated position and an angle of view of the virtual camera.

13. The non-transitory storage medium according to claim 12, wherein the updating includes decreasing the amount of change in the defocusing degree relative to the distance as the distance from the virtual camera to the calculated position becomes longer.

14. The non-transitory storage medium according to claim 13, wherein the updating includes increasing the amount of change in the defocusing degree relative to the distance as the angle of view of the virtual camera becomes larger.

15. The non-transitory storage medium according to claim 1, wherein the calculating includes holding a position corresponding to the indicated position independently of a change in an image capturing direction of the virtual camera.

16. An information processing apparatus adapted to access a display unit and an input unit, comprising:
a display control unit configured to cause a captured image captured by a virtual camera located in a virtual space to be displayed on the display unit;
an indicated position receiving unit configured to receive an indicated position on the captured image from the input unit;
a spatial position calculation unit configured to calculate a position in the virtual space corresponding to the indicated position; and
an image updating unit configured to update the captured image to a state in which ranges close to and distant from the virtual camera with respect to a range proximate to the calculated position are out of focus.

17. An information processing system, comprising:
a display device;
an input device; and
a processing apparatus,
the processing apparatus being configured to perform:
causing a captured image captured by a virtual camera located in a virtual space to be displayed on the display unit;
receiving an indicated position on the captured image from the input device;
calculating a position in the virtual space corresponding to the indicated position; and
updating the captured image to a state in which ranges close to and distant from the virtual camera with respect to a range proximate to the calculated position are out of focus.

18. An information processing method executed by a processing apparatus that is adapted to access a display unit and an input unit, comprising:
causing a captured image captured by a virtual camera located in a virtual space to be displayed on the display unit;
receiving an indicated position on the captured image from the input unit;
calculating a position in the virtual space corresponding to the indicated position; and
updating the captured image to a state in which ranges close to and distant from the virtual camera with respect to a range proximate to the calculated position are out of focus.
